(19) United States
(12) Patent Application Publication
(10) Pub. No.: US 2019/0102786 A1
(43) Pub. Date: Apr. 4, 2019

(54) SERVER AND GAME SERVER

(71) Applicant: Universal Entertainment Corporation, Tokyo (JP)

(72) Inventors: Masaki Oyama, Tokyo (JP); Atsushi Kumita, Tokyo (JP); Toshikazu Jinnouchi, Tokyo (JP)

(21) Appl. No.: 16/143,705

(22) Filed: Sep. 27, 2018

(30) Foreign Application Priority Data
Sep. 29, 2017 (JP) 2017-191726

(51) Int. Cl. G06Q 30/02; G06F 3/0484; G06F 3/0488

(52) U.S. Cl. CPC G06Q 30/0209; G06Q 30/0239; G06F 3/0488; G06F 3/04842; G06Q 30/0283

(57) ABSTRACT

The present invention provides a server and a game server for urging a user to pay. A storage device 13 is connected to the controller 12 of the server 10, and the storage device 13 stores a first item value data in which a first value for each of a plurality of shop items is set, and a second item value data in which at least a part of the same plurality of shop items is set to be less expensive than the first item value data, and when the controller 12 receives a cancel signal after displaying the first shop screen on the display of the terminal 2, in order to display a second shop screen, the controller transmits the second item value stored in the storage device 13 to the terminal 2.

### CROSS-REFERENCE TO RELATED APPLICATION

This Application is Entitled to the benefit of Japanese Pat. App. No. 2017-191726, filed on Friday, Sep. 29, 2017.

### BACKGROUND OF THE INVENTION

### 1. Field of Invention

The present invention relates to a server and a game server.

### 2. Description of Related Art

Patent Document 1 (US Patent Application Publication No. 2013/252742) describes a server system in which a random determination icon for starting a random determination that can be executed once at the time of login is displayed and when the random determination icon is touched, random determination of items usable in the game becomes possible.

### BRIEF SUMMARY OF THE INVENTION

However, in the server system described in Patent Document 1, items are given to the user according to a random determination result that can be executed at the time of login, so it is not possible to urge the user to pay for the item through purchase of items.

Therefore, it is an object of the present invention to provide a server and a game server for urging a user to pay.

In the server of the present invention,
a controller of a server connected to a terminal via a communication line controls to display a first shop screen on a display of the terminal in accordance with an operation by an operation device of the terminal, and in response to the operation of the operation device of the terminal, executes a purchase and paying process and a purchase cancel process of an item, wherein
a storage device is connected to the controller of the server, and the storage device stores a first item value data in which a first value for each of a plurality of shop items is set, and a second item value data in which at least a part of the same plurality of shop items is set to be less expensive than the first item value data,
when the controller receives a cancel signal after displaying the first shop screen on the display of the terminal, in order to display a second shop screen, the controller transmits the second item value stored in the storage device to the terminal.

According to the above configuration, when the cancel signal is received after displaying the first shop screen associated with the first item value data, the second shop screen associated with the second item value data in which at least a part of the plurality of shop items set by the first item value data is set to be less expensive is displayed. As a result, in addition to the first shop screen, the second shop screen for selling items set to be less expensive than the first shop screen is presented to the user, so that the user is urged to pay through purchasing items.

In the server of the present invention, it is preferable that the controller receives the cancel signal from the operation device of the terminal.

According to the above configuration, since the cancel signal is received from the operation device of the terminal, when the user selects a cancel button, the second shop screen can be displayed.

In the server of the present invention, the controller may receive the cancel signal after a lapse of a predetermined time from displaying the first shop screen.

According to the above configuration, the controller of the server can automatically display the second shop screen after a lapse of the predetermined time from displaying the first shop screen without depending on the terminal operation by the user.

The game server of the present invention,
comprising: a game terminal having a display for displaying a game image; a communication port for executing transmission and reception of game data; and a controller for controlling a game displayed on the display in cooperation with the game terminal, wherein the controller controls display of a first shop screen for purchasing an item with a payment on the display of the game terminal, and in response to an operation of the operation device of the game terminal, executes a purchase and paying process and a purchase cancel process of an item, wherein
a storage device is connected to the controller of the game server, and the storage device stores a first item value data in which a first value for each of a plurality of shop items is set, and a second item value data in which at least a part of the same plurality of shop items is set to be less expensive than the first item value data,
when the controller receives a cancel signal after displaying the first shop screen on the display of the game terminal, in order to display a second shop screen, the controller transmits the second item value stored in the storage device to the game terminal.

According to the above configuration, when the cancel signal is received after displaying the first shop screen associated with the first item value data, the second shop screen associated with the second item value data in which at least a part of the plurality of shop items set by the first item value data is set to be less expensive is displayed. As a result, in addition to the first shop screen, the second shop screen for selling items set to be less expensive than the first shop screen is presented to the user, so that the user is urged to pay through purchasing items.

The present invention can urge the user to pay.

### BRIEF DESCRIPTION OF THE DRAWINGS

FIG. 1 is an illustrative view showing a schematic configuration of an information processing system.

FIG. 2A, FIG. 2B, and FIG. 2C are a view showing a specific example of first item value data and second item value data stored in a memory.

FIG. 3A is a view showing a menu screen, FIG. 3B is a view showing a game screen after login, FIG. 3C is a view showing a first shop screen, and FIG. 3D is a view showing a second shop screen.

FIG. 4 is a block diagram showing an electric configuration of a game terminal.

FIG. 5 is an illustrative view showing a display state of the game terminal.

FIG. 6 is a functional block diagram of the game terminal.

FIG. 7 is an illustrative view showing a game content.

FIG. 8 is a flowchart showing a login process.

FIG. 9 is a flowchart of a slot game process.

FIG. 10 is a flowchart of a bonus game process.

FIG. 11 is a flowchart of a random determination game process.

### DETAILED DESCRIPTION OF THE PREFERRED EMBODIMENT

An information processing system 100 including a game server according to the present invention will be described with reference to the drawings.

(Information Processing System: Overview)

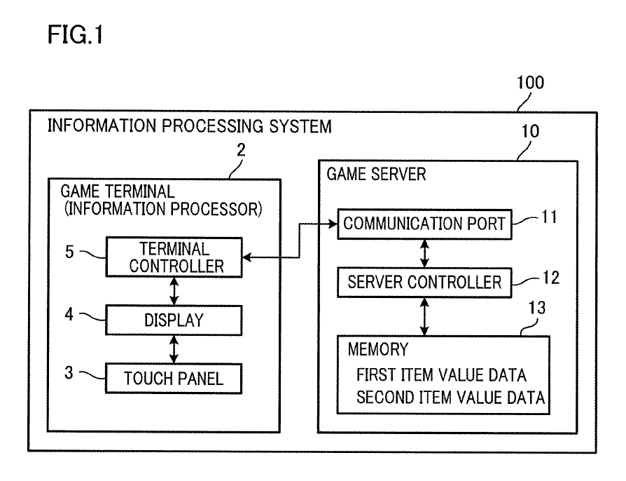

As shown in FIG. 1, the information processing system 100 includes a game terminal 2 (information processor) and a game server 10. When the game terminal 2 which is a computer receives a cancel signal after displaying a first shop screen, the game terminal guides a game player to a second shop screen is set such that at least a part of shop items that can be purchased on the first shop screen is set to be less expensive than the first shop screen. As a result, in addition to the first shop screen, the second shop screen for selling items set to be less expensive than the first shop screen is presented to the user, so that the user is urged to pay through purchasing items.

For example, although it is possible to play a slot game described later using the information processing system 100 of the present embodiment, it is not limited thereto. In addition to the slot game, the information processing system 100 may be used to play various games such as shooting games, action games, adventure games, role playing games, puzzle games, racing games, simulation games and the like.

The game terminal 2 may be either a portable type or a stationary type. As the portable game terminal 2, portable information devices such as a portable computer, a laptop computer, a notebook computer, a tablet type personal computer, a handheld type personal computer, a PDA (personal data assistant), a smartphone, and the like are exemplified. As the stationary game terminal 2, a desktop personal computer and a game machine are exemplified.

The game terminal 2 includes a touch panel 3, a display 4, and a terminal controller 5.

The touch panel 3 is an input device that performs operations related to games. The touch panel 3 is provided on the entire surface of the display 4 and accepts input from the game player. The touch panel 3 accepts, for example, a purchase operation by a user of a shop item on the first shop screen and the second shop screen, which will be described later, and a cancel operation to exit from the first shop screen.

The display 4 is capable of displaying a game screen based on an operation of the touch panel 3. As a display method of the display 4, various display methods such as a liquid crystal method, an organic electroluminescence method, a CRT (Cathode Ray Tube) method, a plasma method and the like are exemplified.

In addition, in the following description, when it is stated that a certain object (for example, a game icon 7 to be described later and the like) has been selected by the user, it means that the game terminal 2 determines to select a certain object for the operation of the user accepted by the touch panel 3.

In addition, in the present embodiment, the touch panel 3 functions as an input device, receives a swipe input and a touch input, and the like, but it is not limited thereto. For example, as the input device, it also may be a microphone or a camera, and a user's voice or gesture may be received as an instruction operation.

The terminal controller 5 is connected to the touch panel 3 and the display 4 and controls at least a part of a game. The terminal controller 5 is communicably connected to the game server 10 via the communication port 11 of the game server 10. As the progress of the game, the terminal controller 5 is caused to download a one-turn of the game program from the game server 10, and it is executed by the terminal controller 5. However, the present invention is not limited thereto, and the progress of the game may be executed by constantly communicating between the game server 10 and the terminal controller 5.

The game server 10 has a communication port 11, a server controller 12, and a memory 13, and is connected to the game terminal 2 through the communication port 11. The game server 10 causes the game terminal 2 to run a game. In addition, in the present embodiment, the game server 10 is employed, but the present invention is not limited thereto, and the present invention may be applied to a shop server used in a mail-order site, for example.

The communication port 11 is a transmission path capable of bidirectional communication such as the Internet, a cable television or the like which performs data communication with the terminal controller 5. The communication port 11 is connected to the server controller 12 and the memory 13.

The server controller 12 controls the game displayed on the display 4 in cooperation with the terminal controller 5 while executing transmission and reception of game data with the terminal controller 5 through the communication port 11. The server controller 12 according to the present embodiment controls to display the first shop screen on the screen (display 4) of the game terminal 2 in accordance with the operation of the touch panel 3 of the game terminal 2, and in accordance with the operation of the touch panel 3 of the game terminal 2, execute a purchase and paying process, and a purchase cancel process of an item. The first shop screen is associated with a first item value data in which a first value for each of the plurality of shop items is set.

In addition, when the server controller 12 receives a cancel signal after displaying the first shop screen on the display 4 of the game terminal 2, in order to display a second shop screen, the server controller transmits a second item value data stored in the memory 13 to the game terminal 2. In the second item value data, at least a part of the plurality of shop items identical to the first item value data is set to be less expensive than the first item value data.

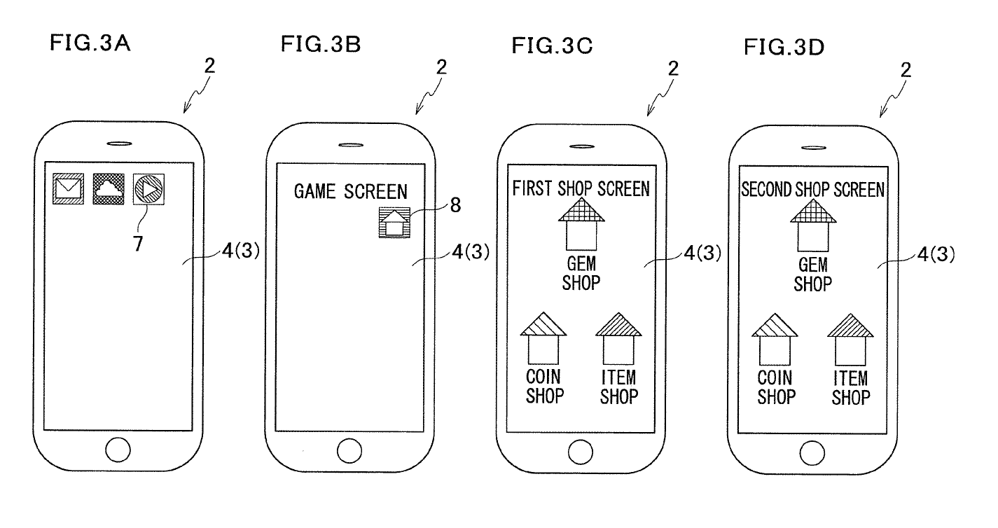

On the shop screen, three types of shops are displayed: a gem shop, a coin shop and an item shop (see FIG. 3C). The game player can arbitrarily visit each shop by operating the touch panel 3. In the gem shop, the gems to be used when purchasing coins can be purchased. In the coin shop, the coins necessary for playing video slots and the like can be purchased. In the item shop, items can be purchased with the gems.

There are three types of shop items purchased on the shop screen: a probability up Item, a high speed spin and a full skip. When the probability up item is used, the appearance rate of the bonus game symbol and the three spin symbol increases. When the high speed spin is used, the speed of spin rises. When the full skip is used, spinning by cutting the bonus and other effect. These items have an expiration date.

Items that can be purchased on the shop screen are used by the game player when playing the slot game using the game terminal 2. Therefore, when playing a game other than the slot game using the game terminal 2 of the present embodiment, an item corresponding to the game to be played is presented to the game player.

The memory 13 is connected to the server controller 10. The memory 13 stores a program to be executed by the game controller 10. The data and program stored in the memory 13 are downloaded and stored by the communication means from the game server 10 or the like, but may be stored in advance at the factory shipping stage.

The server controller 12 performs the following processes in accordance with the game program stored in the memory 13. Specifically, when the server controller 12 receives the cancel signal after displaying the first shop screen on the display 4 of the game terminal 2, in order to display a second shop screen, the server controller performs the following process (A) of transmitting the second item value data stored in the memory 13 to the game terminal 2.

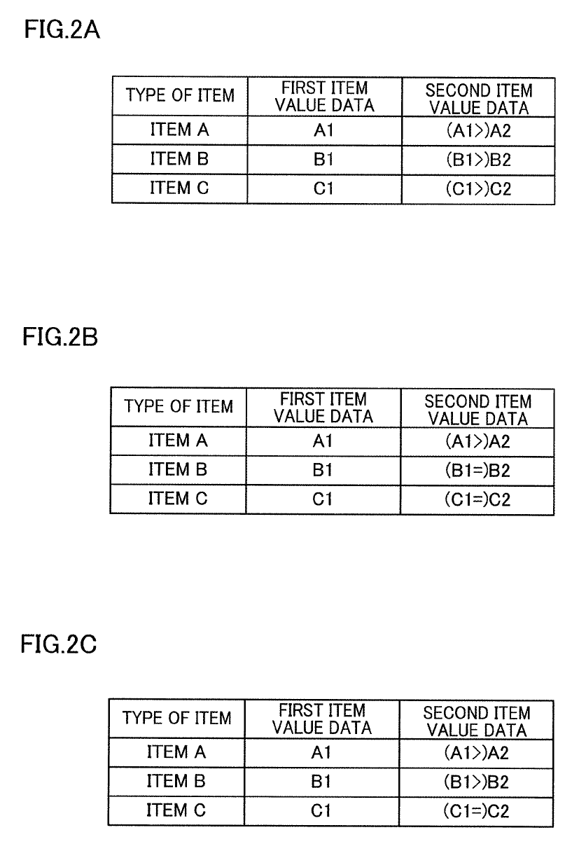

The memory 13 of the present embodiment stores the first item value data and the second item value data. More specifically, as shown in FIG. 2A, among the three types of items in which the item A is the probability up item, the item B is the high speed spin, and the item C is the full skip, the values of all the items each are set to be less expensive in the second item value data than in the first item value data (pattern 1). However, it is not limited thereto, as shown in FIG. 2B, only one of the three types of items, for example, the probability up item of item A is set to be less expensive and values of the other items B (high speed spin), C (full skip) may be set to be a same value in the first item value data and the second item value data (pattern 2). In addition, as shown in FIG. 2C, two types of items, the probability up item of item A and the high speed spin of item B are set to be less expensive, and the value of the other item C (full skip) may be set to be a same value in the first item value data and the second item value data (pattern 3).

The combination of item A (probability up item), item B (high speed spin), item C (full skip) is not particularly limited, and the item A may be the high speed spin, the item B may be the full skip, and the item C may be the probability up item. Also, in the memory 13, a plurality of patterns of the patterns 1 to 3 described above are stored, and a control in which the server controller 12 randomly selects one pattern from these patterns may be adopted. The type of items is not limited to three types. In addition, as described above, when playing a game other than the slot game using the game terminal 2 of the present embodiment, an item corresponding to the game to be played is presented to the game player.

(Game Terminal 2: Screen Display of Display)

The display 4 displays a menu screen on which the game icon 7 for logging in to the game is arranged (see FIG. 3A), a screen on which the shop icon 8 for guiding the game player to the first shop screen at the time of logging in to the game (See FIG. 3B), a first shop screen displaying the first shop (see FIG. 3C), and a second shop screen displaying the second shop (see FIG. 3D).

(Game Terminal 2: Specific Example)

An example of the game terminal 2 will be specifically described. In addition, in the following description, a configuration is described in which a slot game for obtaining a game result based on the symbols when the symbols of the video reel are variably displayed and stopped is executed, but the present invention is not limited thereto. In addition, in the following description, the explanation will be made using the game terminal 2, but the process and operation of the game terminal 2 can be replaced with the invention of a program or game control method.

(Game Terminal 2: Specific Example: Electric Configuration)

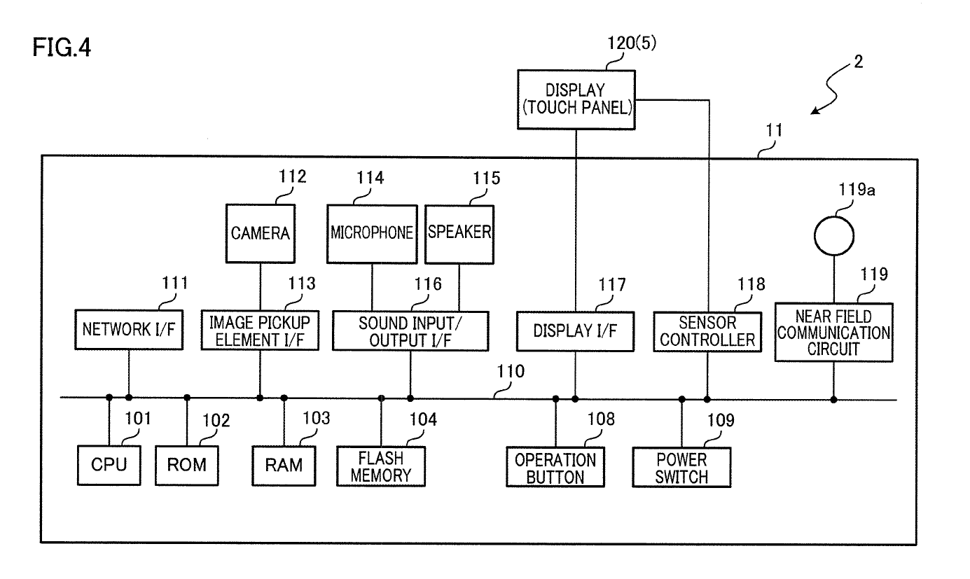

As shown in FIG. 4, the game terminal 2 includes a CPU 101, a ROM 102, a RAM 103, a flash memory 104, an operation button 108, a power switch 109, a bus line 110, a network I/F 111, a camera 112, an image pickup element I/F 113, a microphone 114, A speaker 115, a sound input/output I/F 116, a display I/F 117, a sensor controller 118, a short-range communication circuit 119, and an antenna 119a of the short-range communication circuit 119 are provided in a cabinet 11.

The CPU (Central Processing Unit) 101 controls the overall operation of the game terminal 2. The ROM (Read Only Memory) 102 stores a program used for driving the CPU 101, such as an IPL (Initial Program Loader). In addition, the ROM 102 may store the program of the process (A) described above.

A RAM (Random Access Memory) 103 is used as a work area of the CPU 101. The flash memory 104 stores various data such as the game program, the communication program, the image data, and the sound data having the process (A) etc. of the present invention. The operation button 108 is a button that is operated when the game terminal 2 is initially set. The power switch 109 is a switch for switching ON/OFF of the power of the game terminal 2.

The network I/F (Interface) 111 is interface for performing a data communication by utilizing a communication network such as the Internet. The camera 112 is a kind of built-in type image pickup unit that captures an image of a subject under the control of the CPU 101 to obtain image data. The image pickup element I/F 113 is a circuit that controls driving of the camera 112. The microphone 114 is a kind of built-in type sound collecting unit for inputting a sound. The sound input/output I/F 116 is a circuit for processing input and output of sound signals between the microphone 114 and the speaker 115 under the control of the CPU 101. The display I/F 117 is a circuit that transmits image data to the display 120 under the control of the CPU 101. The display 120 is provided on the front surface of the cabinet 11. The sensor controller 118 is a circuit that receives an input from the touch panel 3 provided on the display 120. The short-range communication circuit 119 is a communication circuit such as an NFC (Near Field Communication) (registered trademark), a Bluetooth (registered trademark), or the like. The bus line 110 is an address bus, a data bus, or the like for electrically connecting each component such as the CPU 101.

(Game Terminal 2: Specific Example: Slot Game)

The game terminal 2 having the above-described electric configuration is a game machine that runs a slot game.

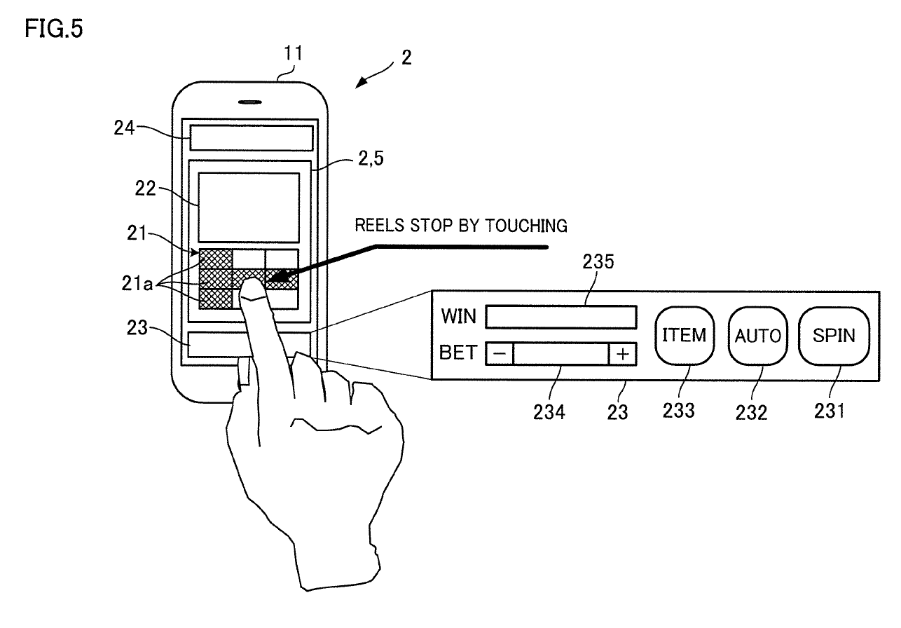

As shown in FIG. 5, a slot game screen is displayed on the display 4 of the game terminal 2 which is a game machine that runs a slot game. The slot game screen includes a game area 21a in which a plurality of symbol display areas are displayed in a configuration of a plurality of rows and a plurality of columns, an effect area 22 displaying a dynamic image or a still image such as a game character with matching to the slot game, an operation area 23 operated by the player for the progress of the game, and a game information display area 24 for displaying game contents and game information. The operation area 23 includes a spin button 231, an AUTO button 232, an ITEM button 233, a BET button 234, and a WIN display portion 235 as images.

The touch panel 3 that transmits the game screen is provided on the entire surface of the display 4. The touch panel 3 makes it possible to detect the coordinate of the site touched by the player's finger or the like. Thus, for example, by pressing the image of the spin button 231, one slot game (unit game) can be executed. In addition, by pressing the image of the AUTO button 232, the slot game can be continuously performed.

(Game terminal 2: Specific Example: Slot Game: Definition)

The base game in the slot game of the present embodiment is a game in which plural symbols are displayed (arranged) by being varied and stopped in the game area 21, and includes a normal game. A state in which a symbol is displayed after being varied and stopped in the game area 21 is termed “rearrangement” As a bonus game, the free game is executed at least once in the slot game. The slot game may include a process of executing a free game where symbols are rearranged on condition that the payout rate is higher than the payout rate in the normal game and a bonus payout is awarded in accordance with the rearranged symbols.

A gaming value which is awarded when a prize is established as a result of a game result is a coin, paper money, or electrically valuable information corresponding to these. Note that the gaming value in the present invention is not particularly limited. Examples of the gaming value include game media such as medals, tokens, cyber money, tickets, and the like. A ticket is not particularly limited, and a barcoded ticket may be adopted for example. Alternatively, the gaming value may be a game point not including valuable information.

The free game is a game which is executable with a smaller amount of gaming values bet than in the normal game. Note that “bet of smaller amounts of gaming values” encompasses a bet of zero gaming value. The “free game” therefore may be a game runnable without a bet of a gaming value, which free game awards an amount of gaming values based on symbols rearranged. In other words, the “free game” may be a game which starts without consumption of a gaming value. To the contrary, the “normal game” is a game runnable on condition that a gaming value is bet, which normal game awards an amount of gaming value based on the symbols rearranged. In other words, the “normal game” is a game which starts with consumption of a gaming value.

The “unit game” is a series of operations from the start of the receiving of a bet to a state in which an award can be established. To put it differently, the unit game includes a single bet time for receiving a bet, a single game time of rearranging stopped symbols, and a single payout time of a payout process of awarding a payout.

A state in which a symbol is displayed after being varied and stopped in the game area 21 is termed “rearrangement” To put it differently, the term “rearrangement” indicates that the symbols are rearranged after the arrangement of the symbols is dismissed. The term “arrangement” indicates a state in which the symbols are visually recognizable by an external player.

(Game Terminal 2: Specific Example: Functional Block)

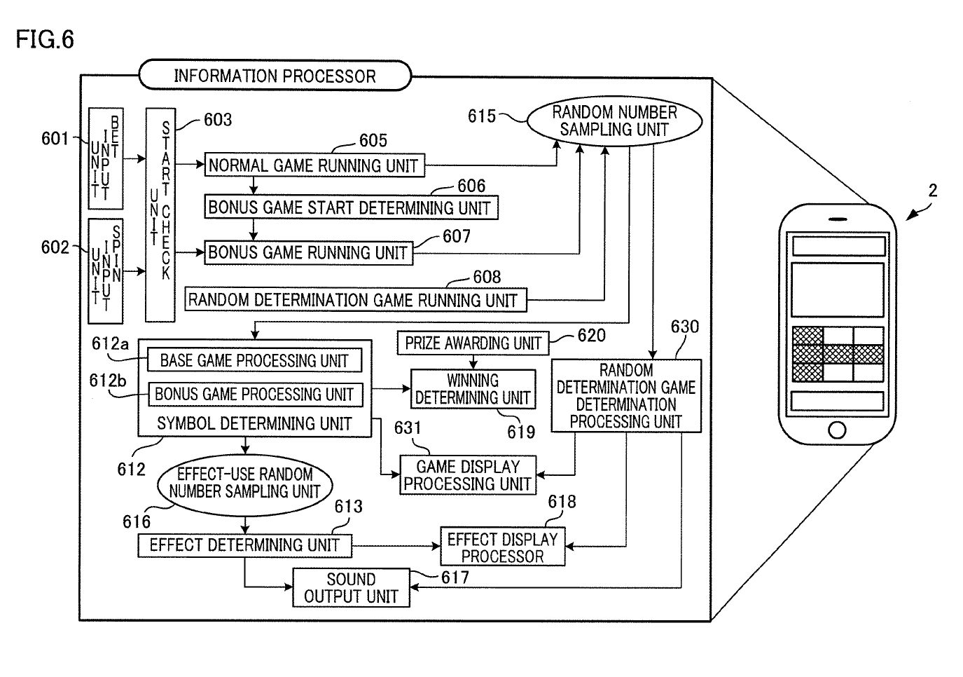

As shown in FIG. 6, the game terminal 2 that is a slot machine which runs the slot game has the following functions. More specifically, the game terminal 2 has a BET input unit 601 and a spin input unit 602. The BET input unit 601 and the spin input unit 602 are a type of input device. The BET input unit 601 has a function of accepting a bet by the operation of a player. The spin input unit 602 has a function of accepting the start of the game by the operation of the player, that is, the start operation.

In addition, the game terminal 2 includes a start check unit 603, a normal game running unit 605, a bonus game start determining unit 606, a bonus game running unit 607, a random determination game running unit 608, a random number sampling unit 615, a symbol determining unit 612, an effect-use random number sampling unit 616, an effect determining unit 613, a sound output unit 617, an effect display processing unit 618, a winning determining unit 619, a prize awarding unit 620, a random determination game determination processing unit 630, and a game display processing unit 631.

The normal game running unit 605 has a function of running a normal game which is a base game on the condition of the operation of the BET input unit 601. The bonus game start determining unit 606 determines whether or not to run a bonus game based on a combination of symbols rearranged in the normal game. That is, when the bonus symbols are rearranged, the bonus game start determining unit 606 determines that the bonus game has been won and transitions the process to the bonus game running unit 607 so as to execute the bonus game from the next unit game. The random determination game running unit 608 has a function of drawing a plurality of prizes including a bonus game and is executed after execution of the bonus game running unit 607 so that the bonus game can be repeatedly executed.

The symbol determining unit 612 includes a base game processing unit 612a and a bonus game processing unit 612b. The symbol determining unit 612 including these processing units 612a and 612b has a function of determining symbols to be rearranged using the random number from the random number sampling unit 615, a function of rearranging the determined symbols on the display 11, a function of outputting the symbol rearrangement information to the winning determining unit 619, and a function of outputting the effect instruction signal to the effect-use random number sampling unit 616 based on a combination of rearrangement of the symbols.

The effect-use random number sampling unit 616 has a function of extracting the effect-use random number when receiving the effect instruction signal from the symbol determining unit 612, and a function of outputting the effect-use random number to the effect determining unit 613. The effect determining unit 613 has a function of determining effect content using the effect-use random number, a function of outputting the image information of the determined effect content to the effect display processing unit 618, and a function of outputting the sound/light emission information of the determined effect content to the sound output unit 617.

The winning determining unit 619 has a function of determining whether the winning has been made based on the combination of symbols when the symbol rearrangement information is obtained, a function of calculating the payout amount based on the winning combination when it is determined that the winning has been made, and a function of outputting a payout signal based on the payout amount to the prize awarding unit 620. The prize awarding unit 620 has a function of paying out the game value to the player.

The random determination game determination processing unit 630 has a function of running a random determination game of awarding prizes including the bonus game based on a random number obtained by random number determination after the end of the bonus game, and outputs effect data of the random determination game to the game display processing unit 631, the effect display processing unit 618, and the sound output unit 617.

(Game Terminal 2: Specific Example: Login)

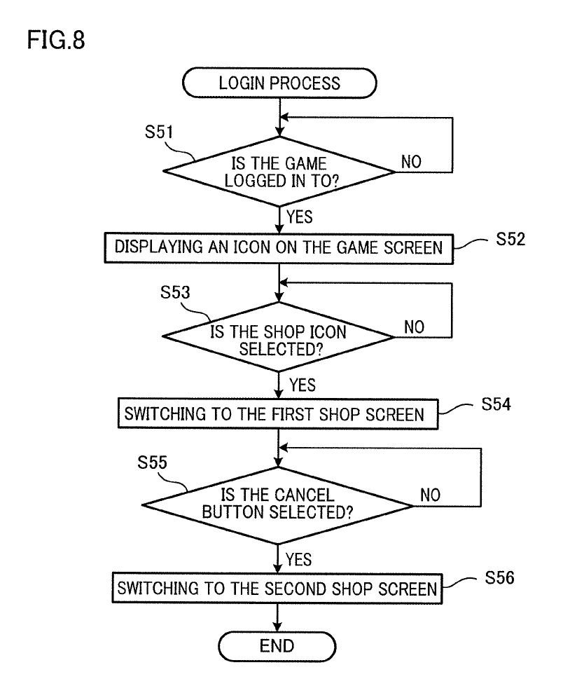

FIG. 8 is a flowchart showing the flow when the game player logs in to the game. In step S51, the terminal controller 5 determines whether or not the game player has logged in to the game. If logged in, the process proceeds to step S52, and if it is not logged in, it repeats. By touching the game icon 7 shown in FIG. 3A, the game player logs in to the game, and the display 4 is switched from the menu screen to the game screen. In step S52, the terminal controller 5 displays the shop icon 8 on the game screen of the display 4 (see FIG. 3B). In step S53, the terminal controller 5 determines whether the user has selected the shop icon 8 or not. When the game player selects the shop icon 8, in step S54, the display 4 is switched from the game screen to the first shop screen (see FIG. 3C). At this time, the server controller 12 transmits the first item value data stored in the memory 13 to the game terminal 2. As a result, on the first shop screen, the value of the item based on the first item value data is presented.

In step S55, the terminal controller 5 determines whether the user has selected the cancel button during the display of the first shop screen. If the user has selected the cancel button, the process proceeds to step S56, and if it is not selected, the process is repeated.

In step S56, the terminal controller 5 switches the display 4 from the first shop screen to the second shop screen. At this time, the server controller 12 transmits the first item value data stored in the memory 13 to the game terminal 2. As a result, on the second shop screen, the value of the item based on the second item value data is presented. In this second item value data, all of the shop items are set to be less expensive than the first item value data. As a result, in addition to the first shop screen, the second shop screen for selling items set to be less expensive than the first shop screen is presented to the user, so that the user is urged to pay through purchasing items.

The login process of the present invention is not limited to the above embodiment, and various modifications may be adopted.

In the following modifications, differences from the above flow will be described.

<Modification 1>

In the embodiment described above, the terminal controller 5 determines whether the user has selected the cancel button during the display of the first shop screen in step S55, and then, in step S56, the display is switched from the first shop screen to the second shop screen, but it is not limited thereto.

For example, a configuration may be adopted in which the display 4 is switched to the second shop screen after a lapse of a predetermined time since the terminal controller 5 displays the first shop screen, regardless of the button operation by the user. Specifically, a timer (not shown) for measuring the time since the first shop screen is displayed is connected to the terminal controller, and after a predetermined time has elapsed from the display of the first shop screen, the terminal controller 5 may switch to the second shop screen.

<Modification 2>

In the above embodiment, only the second item value data of the pattern 1 is stored in the memory 13, but it is not limited thereto, and the second item value data of all the patterns 1 to 3 may be stored in the memory 13. At this time, the server controller 10 randomly selects any one of the second item value data of the patterns 1 to 3 and transmits it to the game terminal 2. As a result, one of a plurality of second shop screens having different items set to be less expensive than the first shop screen is displayed on the display 4.

<Modification 3>

Also, in the above embodiment, when the user selects the cancel button while displaying the first shop screen, the screen is switched to the second shop screen. However, the present invention is not limited thereto, and when the user selects the cancel button while displaying the second shop screen, a second shop screen different from the displayed second shop screen may be displayed. More specifically, all the second item value data of the patterns 1 to 3 are stored in the memory 13. Then, when the user selects the cancel button during the display of the second shop screen of the pattern 1, the game server 10 transmits the second item value data of the pattern 2 to the game terminal 2. As a result, the second shop screen based on the second item value data of the pattern 2 is displayed on the display 4.

<Modification 4>

Furthermore, a measuring unit (not shown) for measuring the number of times for which the user has selected the cancel button during the display of the first shop screen and the second shop screen may be connected to the server controller 12. At this time, an upper limit value of the number of times for which the user has selected the cancel button, such as three times, and all the second item value data of the patterns 1 to 3 are stored in the memory 13. Then, when the user selects the cancel button while displaying the first shop screen, the server controller 10 transmits the second item value data of the pattern 1 to the game terminal 2, and the second shop screen based on this is displayed. Then, when the user selects the cancel button while displaying the first shop screen based on the pattern 1, the server controller 10 transmits the second item value data of the pattern 2 to the game terminal 2, and the second shop screen based on this is displayed. Then, when the user selects the cancel button while displaying the first shop screen based on the pattern 2, the server controller 10 transmits the second item value data of the pattern 3 to the game terminal 2, and the second shop screen based on this is displayed. At this time, since the measuring unit has measured the selection of the cancel button three times, when the user has selected the cancel button thereafter, it exits from the last displayed second shop screen.

In the modification 4, the second shop screen displayed for the first time is based on the price setting of the second item value data of the pattern 1, the second shop screen displayed for the second time is based on the price setting of the second item value data of the pattern 2, and the second shop screen displayed for the third time is based on the price setting of the second item value data of the pattern 3. However, the present invention is not limited thereto, and it is also possible to adopt a configuration in which the price of the same item sequentially decreases in the second shop screens in the second and third time, as compared with in the second shop screen in the first time.

Furthermore, a following configuration may be adopted, in which although the price of the same item is lower on the second shop screen in the second time than in the second shop screen in the first time, the price of the item whose price has decreased for the second time in the second shop screen in the third time may rise and the price of the other item may be lowered, as compared with in the second shop screen in the second time.

In the above embodiment, the shop icon 8 is displayed on the game screen of the display 4 at the time of logging in to the game, but the present invention is not limited thereto, and the shop icon 8 may be displayed on the game screen irrespective of the operation by the user. For example, the terminal controller 5 may display the shop icon 8 on the game screen at a timing when the amount of items owned by the user becomes small.

(Game Terminal 2: Specific Example: Game Content)

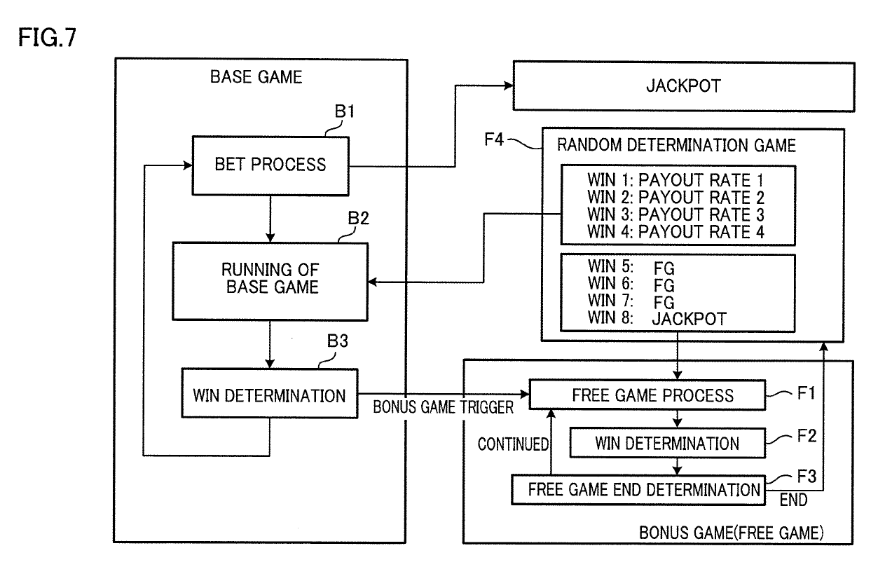

FIG. 7 is a diagram showing a state transition in the game terminal 2 which is a game apparatus. Specifically, it shows transition among the base game mode, the bonus game mode (free game), and the lottery game mode. The base game mode is a game state during the normal game, and the bonus game mode corresponds to the game state during the free game.

The game terminal 2 has three game modes: a base game mode, a bonus game mode, and a random determination game mode. In the game terminal 2, the unit game is executed with the base game mode as a main mode, and when the bonus trigger condition is satisfied in the base game mode, the information processor 1 shifts to the bonus game mode. For example, the trigger of the bonus game is a condition that three or more bonus symbols are repeated (rearranged) from the first reel continuously. In addition, the trigger of the bonus game may be other conditions.

(Game Terminal 2: Specific Example: Game Content: Base Game Mode)

Explaining concretely the base game mode, in the game area 21 displayed on the display 11 of FIG. 5, symbols for the slot game of a video reel can be rearranged in three rows and three columns. In a bet process (B1), the bet amount is selected by the player. For example, selection of 1, 2, 3, 5, 10, etc. for the bet amount is enabled by the operation of the bet button 234. Then, the resource obtained through accumulating a part of these bet amount is taken as a jackpot.

Next, when symbols are rearranged by variable display (scroll movement) and stop display (scroll stop) of the video reels, presence or absence of winning is determined. Then, the win determination is performed based on the rearrangement pattern of the rearranged symbols (B3). For example, if bonus symbols are continuous from the first array area (first reel) to the third array area (third reel), the winning of a bonus game trigger is established. In addition, if the bonus symbols and the wild symbol determined as a substitute for the bonus symbols are continuous, the winning of the bonus game trigger is established.

(Game Terminal 2: Specific Example: Game Content: Bonus Game Mode)

In the base game mode, when the trigger condition of the bonus game is satisfied, the mode is shifted to the bonus game mode, and first the free game process is executed (F1).

In the free game process, a reel strip for the free game to be used during the free game is determined, and a predetermined number of times of execution of the free game is set. In addition, the reel strip and the number of times of execution of the free game for the free game may be set from a random determination among a plurality of selections.

When the free game is executed, a win determination is performed (F2). In addition, the win determination may be the same as the win determination of the base game (B3). For example, when three or more bonus symbols appear consecutively from the first reel, the re-trigger condition of the bonus game (free game) is satisfied.

Thereafter, the end of the free game is determined (F3), and only if the free game has not ended (continued), the remaining free game is executed in F1. On the other hand, when the free game ends, the game shifts to a lottery game (F4).

(Game Terminal 2: Specific Example: Game Content: Random Determination Game Mode)

The random determination game is performed by displaying a random determination game screen on the display 4. The lottery game screen has an effect comment screen such as “chance to obtain a large amount of coins” and a first winning portion to an eighth winning portion which are eight winning display areas. In the case of winning in the first winning portion to the fourth winning portion, the base game will be shifted to.

Each winning portion is corresponding to an award including a bonus game. Specifically, the first winning portion is corresponding to an award that enables a payout of a payout rate that is one times the total payout of the bonus game (multiple free games) performed before the lottery game. The second winning portion is corresponding to an award that enables a payout of a payout ratio doubling the above-mentioned total payout. The third winning portion is corresponding to an award that enables a payout of a payout ratio three times the above-mentioned total payout. The fourth winning portion is corresponding to an award that enables a payout of a payout ratio four times the above-mentioned total payout. The fifth winning portion is corresponding to an award for the bonus game consisting of free game of five games. The sixth winning portion is corresponding to an award for the bonus game consisting of free game of ten games. The seventh winning portion is corresponding to an award for the bonus game consisting of free game of fifteen games. The eighth winning portion is corresponding to an award of jackpot. Here, the jackpot is a payout which is larger than the payout obtained by the stop symbol array in the base game in general, and one in which a part of the payout is accumulated for each bet is an award (progressive jackpot).

(Game Terminal 2: Specific Example: Game Content: Slot Game Process)

Next, program of the slot game executed by the CPU 101 of the game terminal 2 will be described.

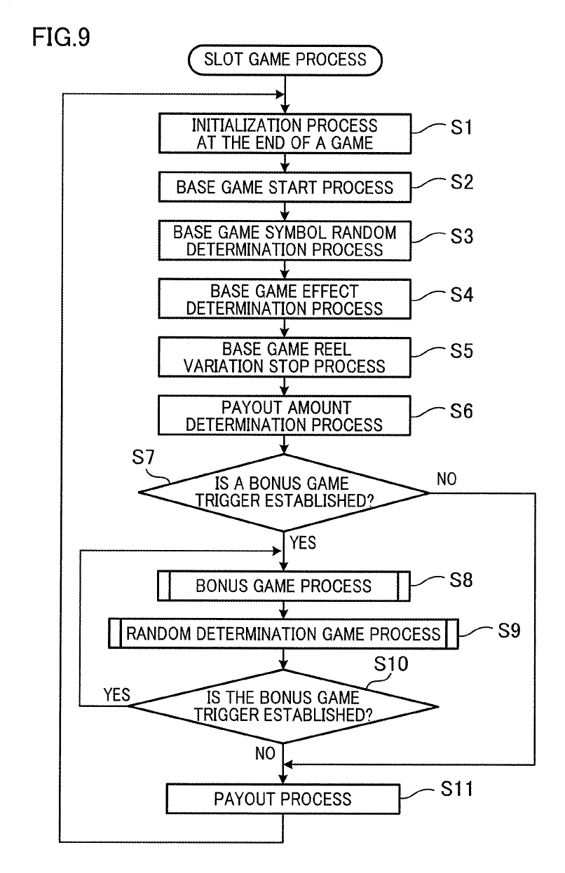

As shown in FIG. 9, an initializing process at the end of each play of the game is executed (S1). For example, this process clears data in a working area of the RAM 103, which becomes unnecessary at the end of each play of game, e.g., the bet amount and symbols selected by random determination. After a base game start process (S2), a base symbol random determination process is executed (S3). In this process, a to-be-stopped symbol based on the random number is selected and determined using the symbol random determination table.

Then a base game effect determination process is executed (S4). The CPU 101 extracts an effect-use random number, determines one of a plurality of predetermined effect contents by random determination, and executes the effect content at the timing of the determined effect content. For example, an effect image is displayed in an effect area 22 of the display 120, and sound is output by the speaker 115.

Then a base game reel variation stop process is executed (S5). In this process, scrolling of the symbol array in the symbol display area 21 is started, and the to-be-stopped symbol determined in the base game symbol random determination process is stopped at a predetermined position.

Then a payout amount determination process is executed (S6). In the base game, a payout amount is determined in accordance with a combination of symbols and based on a payout table, and the determined payout amount is stored in a payout amount storage area of the RAM 103. When the bonus game trigger is established, a payout amount is determined in accordance with a combination of bonus symbols, based on a rule different from the rule in the base game.

Then whether the bonus game trigger has been established is determined (S7). When the bonus game trigger has been established (YES in S7), a bonus game process is executed (S8). Then a later-described random determination game process is executed (S9) and whether the bonus game trigger has been established is determined in the random determination game process (S10). When the bonus game trigger has been established (YES in S10), the bonus game process in S8 is executed again.

In the meanwhile, if the bonus game trigger has not been established in S7 or S10 (NO in S7 or S10), a payout process is executed (S11). The CPU 101 adds a value stored in the payout amount storage area to a value stored in a credit amount storage area (credit counter) provided in the RAM 103. Then the steps are executed again from 51.

(Game Terminal 2: Specific Example: Game Content: Bonus Game Process)

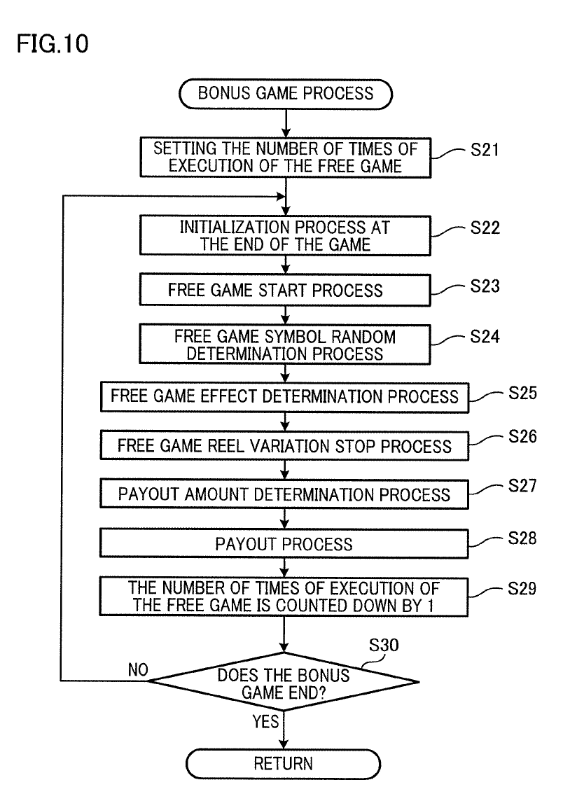

The following describes a bonus game process with reference to FIG. 10. The bonus game process is a process executed when the bonus game trigger is established.

To begin with, the number of times of execution of the free game is set (S21). For example, the number of times of execution of the free game is set at 5. Then an initializing process at the end of each play of the game is executed (S22). For example, this process clears data in a working area of the RAM 103, which becomes unnecessary at the end of each play of game, e.g., the symbols selected by random determination. It is noted that the bet amount in the bonus game is identical with the bet amount in the base game immediately before the shift to the bonus game.

Thereafter, in the same manner as in the base game, a free game start process (S23), a symbol random determination process (S24), and a free game effect determination process (S25) are executed. In the free game, a free game symbol random determination table different from the symbol random determination table in the base game is used. In the free game symbol random determination process, when a Huge Chili flag is set at 1, random determination is executed such that a Huge Chili symbol is to be rearranged.

Thereafter, a free game reel variation stop process (S26) is executed to vary and stop the reels. Thereafter, a payout amount determination process (S27) and a payout process (S28) are serially executed, and then the number of times of execution of the free game is counted down by 1. Then whether the bonus game has ended is determined (S30). When the number of times of execution of the free game is not 0 (NO in S30), the steps are executed again from S22 as it is determined that the bonus game has not ended. In the meanwhile, when the number of times of execution of the free game is 0 (YES in S30), it is determined that the bonus game has ended. The process is then terminated and the processing routine shown in FIG. 9 is resumed.

(Game Terminal 2: Specific Example: Game Content: Random determination Game Process)

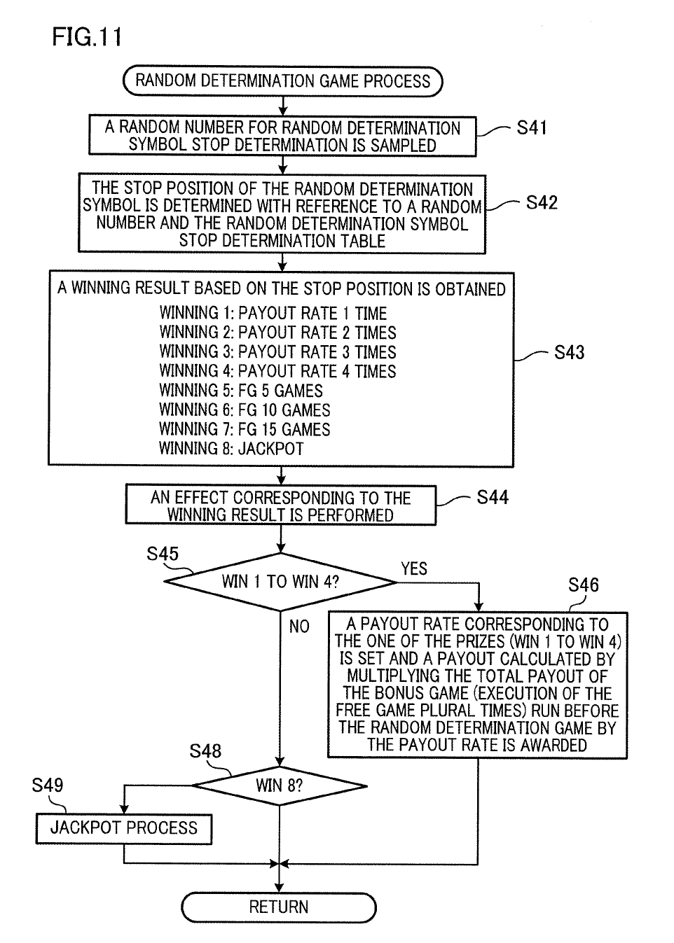

The following describes a random determination game process with reference to FIG. 11. The random determination game process is a process executed when the bonus game ends.

To begin with, a random number for random determination symbol stop determination is sampled (S41). Thereafter, the stop position of the random determination symbol is determined with reference to a random number and the random determination symbol stop determination table (S42). In the present embodiment, the symbol stops at one of the eight winning portions 2521 to 2528. Thereafter, a winning result based on the stop position is obtained (S43). To put it differently, a prize corresponding to one of the winning portions 2521 to 2528 (i.e., one of win 1 to win 8) is obtained. Then an effect corresponding to the winning result is performed (S44).

Subsequently, whether the winning result is one of prizes (win 1 to win 4) is determined (S45). When the result is one of the prizes (win 1 to win 4) (YES in S45), a payout rate corresponding to the one of the prizes (win 1 to win 4) is set and a payout calculated by multiplying the total payout of the bonus game (execution of the free game plural times) run before the random determination game by the payout rate is awarded (S46), and then the routine ends.

On the other hand, if the winning result is not the prize (win 1) to the prize (win 4) (NO in S45), it is determined whether or not the winning result is a prize (win 8) (S 48). When the winning result is a prize (win 8) (YES in S48), a jackpot process is executed, a jackpot payout is performed, and effect for jackpot is performed (S49). Then, this routine is ended. When the winning result is not a prize (win 8) (NO in S48), the bonus game trigger is set so that the bonus game is repeated (S50), and this routine is ended.

Although the embodiment of the present invention has been described above, it is merely a specific example, and the present invention is not particularly limited, and the specific configuration of each means and the like can be appropriately designed and changed. In addition, the effects described in the embodiments of the present invention are merely a list of the most preferable effects produced by the present invention, and the effects of the present invention are not limited to those described in the embodiments of the present invention. [symbol] terminal.

What is claimed is:

1. A server, wherein:
a controller of the server connected to a terminal via a communication line controls to display a first shop screen on a screen of the terminal in accordance with an operation of an operation device of the terminal, and in response to the operation of the operation device of the terminal, executes a purchase and paying process and a purchase cancel process of an item, wherein
a storage device is connected to the controller of the server, and the storage device stores a first item value data in which a first value for each of a plurality of shop items is set, and a second item value data in which at least a part of the same plurality of shop items is set to be less expensive than the first item value data,
when the controller receives a cancel signal after displaying the first shop screen on the screen of the terminal, in order to display a second shop screen, the controller transmits the second item value stored in the storage device to the terminal.

2. The server according to claim 1, wherein, the controller receives the cancel signal from the operation device of the terminal.

3. The server according to claim 1, wherein, the controller receive the cancel signal after a lapse of a predetermined time from displaying the first shop screen.

4. A game server, comprising:
a game terminal having a display for displaying a game image; a communication port for executing transmission and reception of game data; and a controller for controlling a game displayed on the display in cooperation with the game terminal, wherein the controller controls display of a first shop screen for purchasing an item with a payment on the display of the game terminal, and in response to an operation of the operation device of the game terminal, executes a purchase and paying process and a purchase cancel process of an item, wherein
a storage device is connected to the controller of the game server, and the storage device stores a first item value data in which a first value for each of a plurality of shop items is set, and a second item value data in which at least a part of the same plurality of shop items is set to be less expensive than the first item value data,
when the controller receives a cancel signal after displaying the first shop screen on the display of the game terminal, in order to display a second shop screen, the controller transmits the second item value stored in the storage device to the game terminal.
